(19) United States
(12) Patent Application Publication
(10) Pub. No.: US 2012/0249923 A1
(43) Pub. Date: Oct. 4, 2012

(54) Display Module, Display Device, and Liquid Crystal Television Set

(75) Inventor: Akifumi KONO, Daito-shi (JP)

(73) Assignee: Funai Electric Co., Ltd., Daito-shi (JP)

(21) Appl. No.: 13/419,077

(22) Filed: Mar. 13, 2012

(30) Foreign Application Priority Data
Mar. 29, 2011 (JP) 2011-72738

(51) Int. Cl. G02F 1/1335; F21V 7/04

(52) U.S. Cl. 349/62; 362/609

(57) ABSTRACT

This display module includes a display cell, a light source, a light guide plate, and a reflective sheet arranged on a side opposite to the display cell with respect to the light guide plate. A projecting portion protruding toward the light guide plate and coming into contact with the light guide plate is formed on a surface of the reflective sheet closer to the light guide plate.

### BACKGROUND OF THE INVENTION

1. Field of the Invention

The present invention relates to a display module, a display device, and a liquid crystal television set, and more particularly, it relates to a display module, a display device, and a liquid crystal television set each including a light guide plate guiding light received from a light source to a display cell and a reflective sheet reflecting the light received by the light guide plate toward the display cell.

2. Description of the Background Art

A display module including a light guide plate guiding light received from a light source to a display cell and a reflective sheet reflecting the light received by the light guide plate toward the display cell is known in general, as disclosed in Japanese Patent Laying-Open No. 2010-72262, for example.

The aforementioned Japanese Patent Laying-Open No. 2010-72262 discloses a liquid crystal display device including a light guide plate guiding light received from an LED (light emitting diode) element (light source) to a liquid crystal panel (display cell) and a reflective sheet reflecting the light received by the light guide plate toward the liquid crystal panel. In this liquid crystal display device, the LED element, the liquid crystal panel, the light guide plate, and the reflective sheet are held by a panel frame made of metal. Furthermore, in this liquid crystal display device, the reflective sheet, the light guide plate, and the liquid crystal panel are stacked on the panel frame in this order, and the substantially entire lower surface of the light guide plate and the substantially entire upper surface of the reflective sheet are in contact with each other. Thus, heat generated when the LED element emits the light is transferred to the liquid crystal panel through the panel frame, the reflective sheet, and the light guide plate.

In the liquid crystal display device disclosed in the aforementioned Japanese Patent Laying-Open No. 2010-72262, however, the substantially entire lower surface of the light guide plate and the substantially entire upper surface of the reflective sheet are in contact with each other, so that the heat transferred from the LED element (light source) to the reflective sheet through the panel frame is easily transferred to the light guide plate. Consequently, the heat from the LED element is disadvantageously easily transferred to the liquid crystal panel (display cell) through the reflective sheet and the light guide plate.

### SUMMARY OF THE INVENTION

The present invention has been proposed in order to solve the aforementioned problem, and an object of the present invention is to provide a display module, a display device, and a liquid crystal television set each capable of inhibiting transfer of heat from a light source to a display cell through a reflective sheet and a light guide plate.

A display module according to a first aspect of the present invention includes a display cell, a light source, a light guide plate including a light-receiving surface receiving light from the light source, guiding the light received by the light-receiving surface to the display cell, and a reflective sheet reflecting the light received by the light-receiving surface of the light guide plate toward the display cell, arranged on a side opposite to the display cell with respect to the light guide plate, while a projecting portion protruding toward the light guide plate and coming into contact with the light guide plate is formed on a surface of the reflective sheet closer to the light guide plate.

In the display module according to the first aspect of the present invention, as hereinabove described, the projecting portion protruding toward the light guide plate and coming into contact with the light guide plate is provided on the surface of the reflective sheet closer to the light guide plate, whereby spaces including air having small thermal conductivity can be provided between the light guide plate and the reflective sheet. Furthermore, a contact area between the light guide plate and the reflective sheet can be further reduced as compared with a case where a surface of the light guide plate is in contact with the substantially entire surface of the reflective sheet closer to the light guide plate. Consequently, transfer of heat from the light source to the display cell through the reflective sheet and the light guide plate can be inhibited.

In the aforementioned display module according to the first aspect, the projecting portion is preferably formed in a shape having side surfaces and a contact surface coming into surface contact with the light guide plate. According to this structure, the projecting portion having the contact surface coming into surface contact with the light guide plate can stably support the light guide plate dissimilarly to a case where the projecting portion is formed in such a shape that the projecting portion comes into point contact with the light guide plate. Consequently, the transfer of heat from the light source to the display cell through the reflective sheet and the light guide plate can be inhibited while the light guide plate is stably supported.

In the aforementioned display module according to the first aspect, a plurality of the projecting portions are preferably formed on the surface of the reflective sheet closer to the light guide plate. According to this structure, the light guide plate can be stably supported by the plurality of projecting portions.

In this case, the plurality of projecting portions are preferably arranged over a substantially entire region of the surface of the reflective sheet closer to the light guide plate. According to this structure, the light guide plate can be more stably supported by the plurality of projecting portions arranged over the substantially entire region of the surface of the reflective sheet closer to the light guide plate.

In the aforementioned display module having the plurality of projecting portions arranged over the substantially entire region of the surface of the reflective sheet closer to the light guide plate, the plurality of projecting portions are preferably arranged substantially uniformly over the substantially entire region of the surface of the reflective sheet closer to the light guide plate. According to this structure, the light guide plate can be further stably supported by the plurality of projecting portions arranged substantially uniformly over the substantially entire region of the surface of the reflective sheet closer to the light guide plate.

In the aforementioned display module formed with the plurality of projecting portions, an arrangement interval between the plurality of projecting portions is preferably larger than a protrusion height of each of the projecting portions. According to this structure, the spaces including air having small thermal conductivity, surrounded by the projecting portions, the light guide plate, and the reflective sheet can be further widened as compared with a case where the arrangement interval between the plurality of projecting portions is smaller than the protrusion height of each of the projecting portions, so that the transfer of heat from the light source to the display cell through the reflective sheet and the light guide plate can be further inhibited.

The aforementioned display module according to the first aspect preferably further includes a heat radiation member having a function of radiating heat from the light source, so provided as to come into contact with a surface of the reflective sheet opposite to the surface on which the projecting portion is formed. According to this structure, heat transferred from the light source to the reflective sheet can be reduced by the heat radiation member having a function of radiating heat from the light source.

In this case, the heat radiation member preferably includes a plate-like member made of metal. According to this structure, the heat transferred from the light source to the reflective sheet can be easily reduced by the plate-like member made of metal.

In the aforementioned display module according to the first aspect, a recess portion having a shape corresponding to a shape of the projecting portion is preferably formed at a position, corresponding to the projecting portion, of a surface of the reflective sheet opposite to the light guide plate. According to this structure, transfer of heat from the light source to the reflective sheet can be more effectively inhibited by a space including air having small thermal conductivity, constituted by the recess portion.

In the aforementioned display module according to the first aspect, the projecting portion is preferably formed integrally on the surface of the reflective sheet closer to the light guide plate. According to this structure, the number of components can be reduced dissimilarly to a case where the projecting portion and the reflective sheet are provided separately from each other.

A display device according to a second aspect of the present invention includes a display module and a housing storing the display module inside, while the display module includes a display cell, a light source, a light guide plate including a light-receiving surface receiving light from the light source, guiding the light received by the light-receiving surface to the display cell, and a reflective sheet reflecting the light received by the light-receiving surface of the light guide plate toward the display cell, arranged on a side opposite to the display cell with respect to the light guide plate, and a projecting portion protruding toward the light guide plate and coming into contact with the light guide plate is formed on a surface of the reflective sheet of the display module closer to the light guide plate.

In the display device according to the second aspect of the present invention, as hereinabove described, the projecting portion protruding toward the light guide plate and coming into contact with the light guide plate is provided on the surface of the reflective sheet of the display module closer to the light guide plate, whereby spaces including air having small thermal conductivity can be provided between the light guide plate and the reflective sheet. Furthermore, a contact area between the light guide plate and the reflective sheet can be further reduced as compared with a case where a surface of the light guide plate is in contact with the substantially entire surface of the reflective sheet closer to the light guide plate. Consequently, the display device capable of inhibiting transfer of heat from the light source to the display cell through the reflective sheet and the light guide plate can be provided.

In the aforementioned display device according to the second aspect, the projecting portion is preferably formed in a shape having side surfaces and a contact surface coming into surface contact with the light guide plate. According to this structure, the projecting portion having the contact surface coming into surface contact with the light guide plate can stably support the light guide plate dissimilarly to a case where the projecting portion is formed in such a shape that the projecting portion comes into point contact with the light guide plate. Consequently, the transfer of heat from the light source to the display cell through the reflective sheet and the light guide plate can be inhibited while the light guide plate is stably supported.

In the aforementioned display device according to the second aspect, a plurality of the projecting portions are preferably formed on the surface of the reflective sheet closer to the light guide plate. According to this structure, the light guide plate can be stably supported by the plurality of projecting portions.

In this case, the plurality of projecting portions are preferably arranged over a substantially entire region of the surface of the reflective sheet closer to the light guide plate. According to this structure, the light guide plate can be more stably supported by the plurality of projecting portions arranged over the substantially entire region of the surface of the reflective sheet closer to the light guide plate.

In the aforementioned display device having the plurality of projecting portions arranged over the substantially entire region of the surface of the reflective sheet closer to the light guide plate, the plurality of projecting portions are preferably arranged substantially uniformly over the substantially entire region of the surface of the reflective sheet closer to the light guide plate. According to this structure, the light guide plate can be further stably supported by the plurality of projecting portions arranged substantially uniformly over the substantially entire region of the surface of the reflective sheet closer to the light guide plate.

In the aforementioned display device formed with the plurality of projecting portions, an arrangement interval between the plurality of projecting portions is preferably larger than a protrusion height of each of the projecting portions. According to this structure, the spaces including air having small thermal conductivity, surrounded by the projecting portions, the light guide plate, and the reflective sheet can be further widened as compared with a case where the arrangement interval between the plurality of projecting portions is smaller than the protrusion height of each of the projecting portions, so that the transfer of heat from the light source to the display cell through the reflective sheet and the light guide plate can be further inhibited.

The aforementioned display device according to the second aspect preferably further includes a heat radiation member having a function of radiating heat from the light source, so provided as to come into contact with a surface of the reflective sheet opposite to the surface on which the projecting portion is formed. According to this structure, heat transferred from the light source to the reflective sheet can be reduced by the heat radiation member having a function of radiating heat from the light source.

In this case, the heat radiation member preferably includes a plate-like member made of metal. According to this structure, the heat transferred from the light source to the reflective sheet can be easily reduced by the plate-like member made of metal.

In the aforementioned display device according to the second aspect, a recess portion having a shape corresponding to a shape of the projecting portion is preferably formed at a position, corresponding to the projecting portion, of a surface of the reflective sheet opposite to the light guide plate. According to this structure, transfer of heat from the light source to the reflective sheet can be more effectively inhibited by a space including air having small thermal conductivity, constituted by the recess portion.

A liquid crystal television set according to a third aspect of the present invention includes a liquid crystal display module, and a television housing storing the liquid crystal display module inside, while the liquid crystal display module includes a liquid crystal display cell, a light source, a light guide plate including a light-receiving surface receiving light from the light source, guiding the light received by the light-receiving surface to the liquid crystal display cell, and a reflective sheet reflecting the light received by the light-receiving surface of the light guide plate toward the liquid crystal display cell, arranged on a side opposite to the liquid crystal display cell with respect to the light guide plate, and a projecting portion protruding toward the light guide plate and coming into contact with the light guide plate is formed on a surface of the reflective sheet of the liquid crystal display module closer to the light guide plate.

In the liquid crystal television set according to the third aspect of the present invention, as hereinabove described, the projecting portion protruding toward the light guide plate and coming into contact with the light guide plate is provided on the surface of the reflective sheet of the liquid crystal display module closer to the light guide plate, whereby spaces including air having small thermal conductivity can be provided between the light guide plate and the reflective sheet. Furthermore, a contact area between the light guide plate and the reflective sheet can be further reduced as compared with a case where a surface of the light guide plate is in contact with the substantially entire surface of the reflective sheet closer to the light guide plate. Consequently, the liquid crystal television set capable of inhibiting transfer of heat from the light source to the liquid crystal display cell through the reflective sheet and the light guide plate can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a liquid crystal television according to an embodiment of the present invention;

FIG. 2 is an exploded perspective view showing the inner structure a television body of the liquid crystal television according to the embodiment of the present invention;

FIG. 3 is a sectional view taken along the line 200-200 in FIG. 2;

FIG. 4 is a perspective view showing the structure of LEDs and a glass epoxy board of a liquid crystal display module according to the embodiment of the present invention;

FIG. 5 is a plan view showing the liquid crystal display module according to the embodiment of the present invention, from which a front bezel, a liquid crystal display cell, and a molded frame have been removed;

FIG. 6 is a sectional view taken along the line 300-300 in FIG. 5; and

FIG. 7 is a sectional view of a reflective sheet and a rear plate of a liquid crystal display module according to a modification of the embodiment of the present invention.

### DESCRIPTION OF THE PREFERRED EMBODIMENTS

An embodiment of the present invention is now described with reference to the drawings.

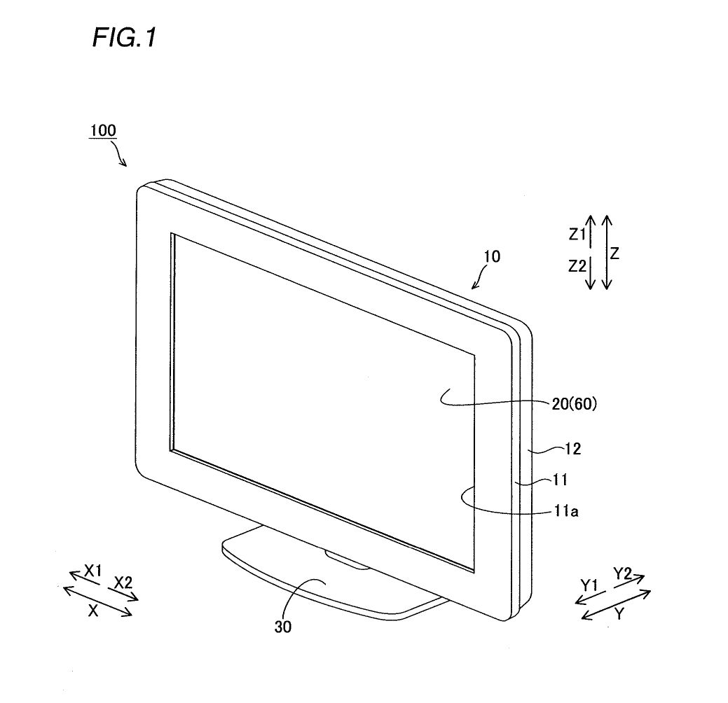

First, the structure of a liquid crystal television 100 according to the embodiment of the present invention is described with reference to FIGS. 1 to 6. The liquid crystal television 100 is examples of the “display device” and the “liquid crystal television set” in the present invention.

The liquid crystal television 100 according to the embodiment of the present invention includes a television body 10 having a display portion 20 displaying an image and a stand member 30 supporting the television body 10 from below (along arrow Z1), as shown in FIG. 1.

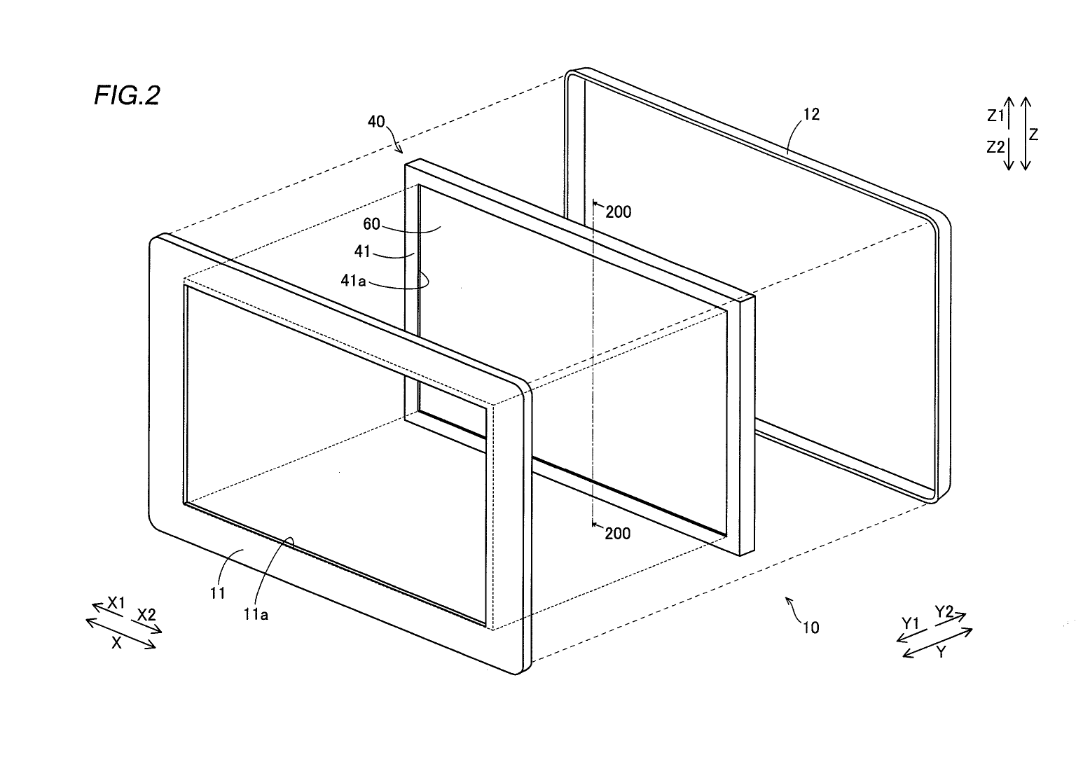

As shown in FIGS. 1 and 2, the television body 10 includes a front cabinet 11 and a rear cabinet 12 each made of resin and a liquid crystal display module 40 having a liquid crystal display cell 60 constituting the display portion 20. The front cabinet 11 and the rear cabinet 12 are examples of the “housing” in the present invention while the same are examples of the “television housing” in the present invention. The liquid crystal display cell 60 is an example of the “display cell” in the present invention. The liquid crystal display module 40 is an example of the “display module” in the present invention.

The front cabinet 11 is arranged on the front side (along arrow Y1) of the liquid crystal television 100.

This front cabinet 11 has a frame shape as viewed from the front side (along arrow Y1). Specifically, the front cabinet 11 has a substantially rectangular outer shape as viewed from the front side (along arrow Y1) and a substantially rectangular opening 11a. The opening 11a is provided to expose the display portion 20 (liquid crystal display cell 60 of the liquid crystal display module 40).

The rear cabinet 12 is arranged on the rear side (along arrow Y2) of the liquid crystal television 100. This rear cabinet 12 is so formed as to be fitted into the front cabinet 11. The rear cabinet 12 has a substantially rectangular outer shape as viewed from the front side (along arrow Y1) and is formed in a concave shape concaved rearward (along arrow Y2).

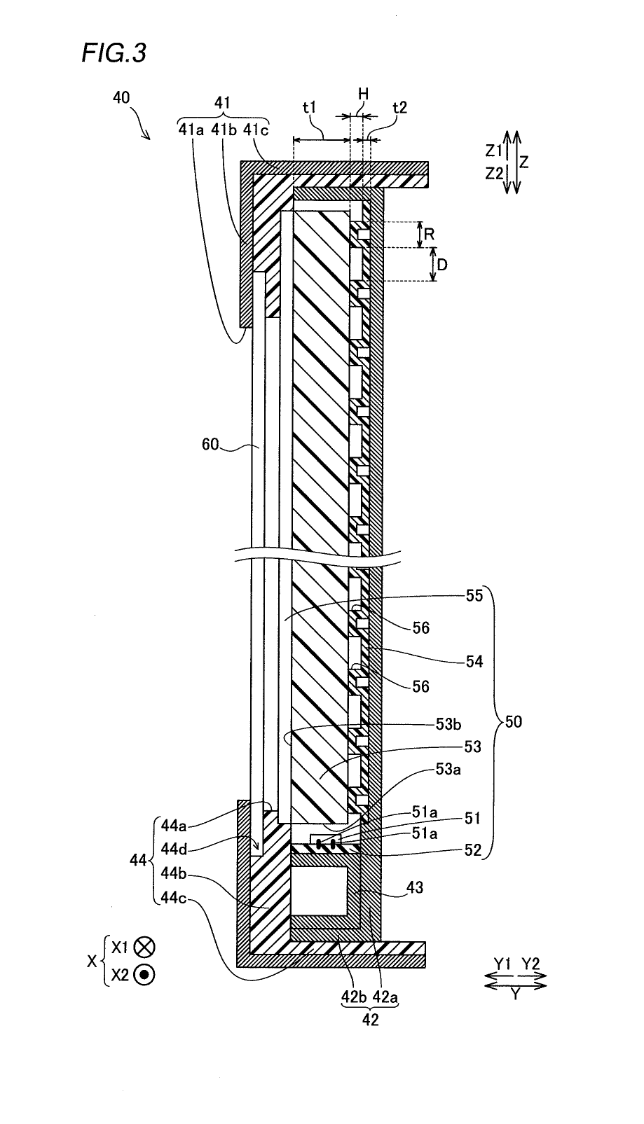

As shown in FIG. 2, the liquid crystal display module 40 is stored inside the front cabinet 11 and the rear cabinet 12 of the television body 10. As shown in FIG. 3, the liquid crystal display module 40 includes a front bezel 41 and a rear plate 42 both made of metal such as aluminum and a heat sink 43, a molded frame 44, a backlight portion 50, and the liquid crystal display cell 60 all arranged between the front bezel 41 and the rear plate 42. The rear plate 42 is examples of the “heat radiation member” and the “plate-like member” in the present invention.

As shown in FIGS. 2 and 3, the front bezel 41 is arranged on the front side (along arrow Y1) of the liquid crystal display module 40. This front bezel 41 is mounted on the rear surface (surface extending along arrow Y2) of the front cabinet 11. The front bezel 41 has a substantially rectangular outer shape as viewed from the front side (along arrow Y1) and a substantially rectangular opening 41a. The opening 41a is provided to expose the liquid crystal display cell 60. The opening area of the opening 41a of the front bezel 41 is larger than the opening area of the opening 11a of the front cabinet 11. According to this embodiment, the front bezel 41 has a bottom portion 41b having the opening 41a and a wall portion 41c extending in a direction (along arrow Y2) substantially perpendicular to the bottom portion 41b from the outer periphery (both end portions in directions Y and Z) of the bottom portion 41b, as shown in FIG. 3.

As shown in FIGS. 2 and 3, the rear plate 42 is arranged on the rear side (along arrow Y2) of the liquid crystal display module 40. This rear plate 42 has a substantially rectangular outer shape as viewed from the front side (along arrow Y1) and is formed in a concave shape concaved rearward (along arrow Y2), as shown in FIGS. 3 and 5. Specifically, the rear plate 42 has a plate-like bottom portion 42a having no opening and a plate-like wall portion 42b extending in a direction (along arrow Y1) substantially perpendicular to the bottom portion 42a from the outer periphery (both end portions in the directions Y and Z) of the bottom portion 42a, as shown in FIG. 3.

According to this embodiment, the rear plate 42 is so arranged that the bottom surface (surface, extending along arrow Y1, of the bottom portion 42a) of the rear plate 42 comes into contact with a surface (surface extending along arrow Y2) of a reflective sheet 54 described later opposite to a surface on which projecting portions 56 are formed. Furthermore, according to this embodiment, the rear plate 42 has a function of radiating heat transferred from LEDs 51 described later.

According to this embodiment, the heat sink 43 made of metal such as aluminum is mounted on the inner surface of the wall portion 42b of the rear plate 42 on the lower side (along arrow Z2). This heat sink 43 is so formed as to have a U-shaped section coming into contact with the inner surface of the wall portion 42b of the rear plate 42 on the lower side (along arrow Z2), the bottom surface (surface, extending along arrow Y1, of the bottom portion 42a) of the rear plate 42 on the lower side (along arrow Z2), and a surface (surface extending along arrow Z2) of a glass epoxy board 52 described later opposite to the LEDs 51.

As shown in FIG. 3, the molded frame 44 is so arranged as to come into contact with the bottom surface (surface, extending along arrow Y2, of the bottom portion 41b) of the front bezel 41 and the inner surface of the wall portion 41c. This molded frame 44 has a bottom portion 44b having an opening 44a and a wall portion 44c extending in a direction (along arrow Y2) substantially perpendicular to the bottom portion 44b from the outer periphery (both end portions in the directions Y and Z) of the bottom portion 44b. A step portion 44d is provided on a portion of the bottom portion 44b of the molded frame 44 closer to the front bezel 41 in the periphery of the opening 44a. The vicinity (vicinity of the both end portions in the directions Y and Z) of the outer periphery of the plate-like liquid crystal display cell 60 extending vertically (in the direction Z) and horizontally (in a direction X) is held between this step portion 44d and the front bezel 41. The inner surface of the wall portion 44c of the molded frame 44 is in contact with the outer surface of the wall portion 42b of the rear plate 42.

As shown in FIG. 3, the backlight portion 50 is held inside a space formed in a region where the bottom surface (surface, extending along arrow Y1, of the bottom portion 42a) of the rear plate 42 and the bottom surface (surface, extending along arrow Y2, of the bottom portion 44b) of the molded frame 44 are opposed to each other. This backlight portion 50 is so formed as to apply light to the rear surface (surface extending along arrow Y2) of the liquid crystal display cell 60 from behind (along arrow Y1). Specifically, the backlight portion 50 includes the LEDs 51 emitting light, the glass epoxy board 52 mounted with the LEDs 51, a light guide plate 53 guiding the light received from the LEDs 51 to the liquid crystal display cell 60, the reflective sheet 54 reflecting the light received by the light guide plate 53 toward the liquid crystal display cell 60, and an optical sheet 55 adjusting the luminance or the like of the light emitted from the light guide plate 53. The LEDs 51 are examples of the “light source” in the present invention.

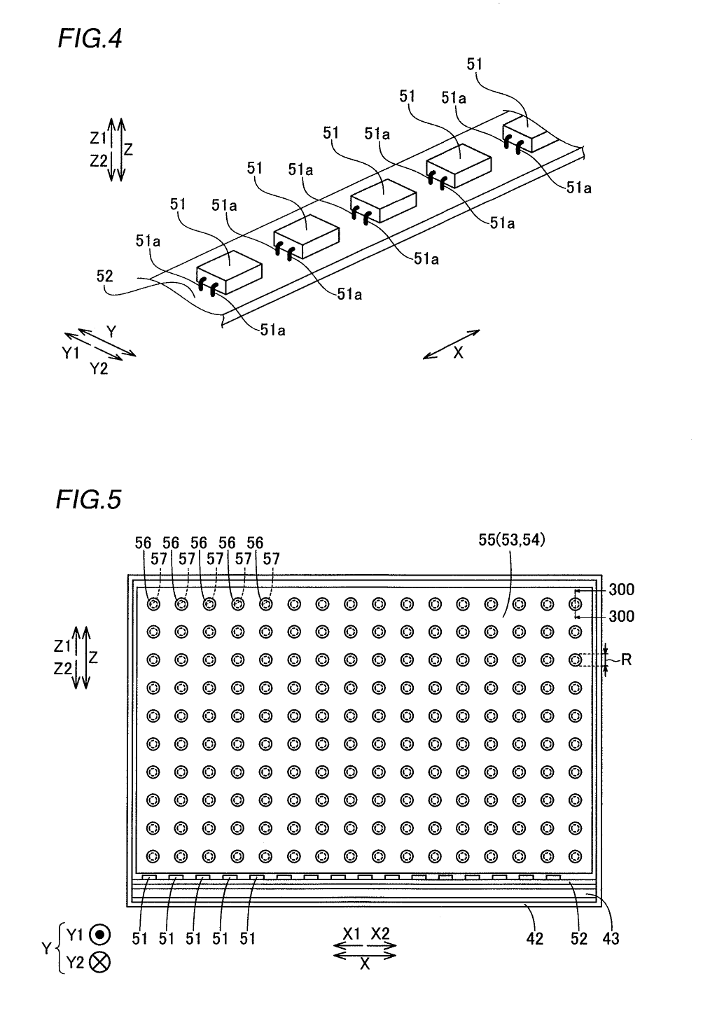

As shown in FIG. 3, the LEDs 51 and the glass epoxy board 52 are mounted on the heat sink 43 arranged on the lower side (along arrow Z2) of the rear plate 42. A plurality of LEDs 51 are mounted on the plate-like glass epoxy board 52 extending horizontally (in the direction X) at prescribed intervals along the extensional direction (direction X) of the glass epoxy board 52, as shown in FIG. 4. The LEDs 51 and the glass epoxy board 52 are connected to each other through lead terminals 51a.

As shown in FIGS. 3 and 5, the light guide plate 53 is arranged above the LEDs 51 (along arrow Z1) at a prescribed interval and has a substantially rectangular shape in plan view (as viewed along arrow Y1). The light guide plate 53 is made of resin such as acrylic allowing transmission of light. The light guide plate 53 is arranged on the rear surface side (along arrow Y2) of the liquid crystal display cell 60 and provided in the form of a plate extending vertically (direction Z) and horizontally (direction X). This plate-like light guide plate 53 has a thickness t1 (see FIG. 3) of about 2 mm.

As shown in FIGS. 3 and 5, the reflective sheet 54 is arranged on the rear surface side (along arrow Y2) of the light guide plate 53 and provided in the form of a plate extending vertically (direction Z) and horizontally (direction X). This plate-like reflective sheet 54 has a thickness t2 (see FIG. 3) of about 0.2 mm. The reflective sheet 54 has a substantially rectangular shape in plan view (as viewed along arrow Y1), as shown in FIG. 5. The reflective sheet 54 is made of resin such as PET (polyethylene terephthalate) having light reflective properties.

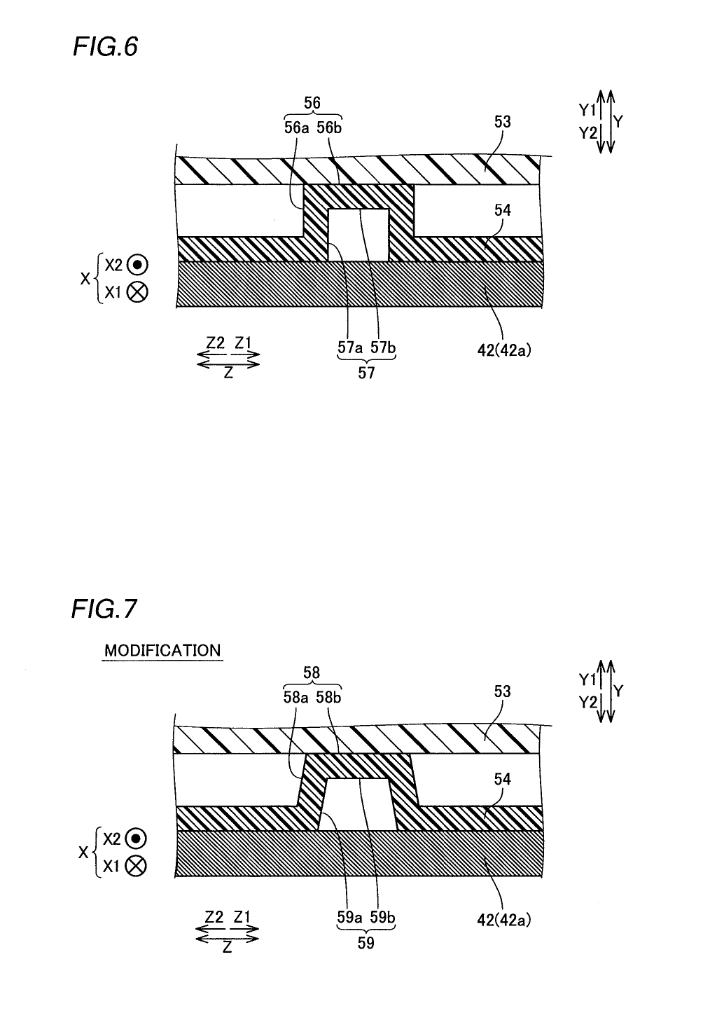

According to this embodiment, the projecting portions 56 protruding toward the light guide plate 53 (along arrow Y1) and coming into contact with the light guide plate 53 are formed on a surface (surface extending along arrow Y1) of the reflective sheet 54 closer to the light guide plate 53, as shown in FIGS. 3, 5, and 6. These projecting portions 56 each have a rectangular section, as shown in FIG. 6. Specifically, the projecting portions 56 each are formed in a shape having side surfaces 56a extending in a direction (along arrow Y1) substantially perpendicular to the reflective sheet 54 and a contact surface 56b coming into surface contact with the light guide plate 53. The projecting portions 56 are formed integrally on the plate-like reflective sheet 54 by texturing.

According to this embodiment, recess portions 57 having shapes corresponding to the shapes of the projecting portions 56 are formed at positions, corresponding to the projecting portions 56, of a surface (surface extending along arrow Y2) of the reflective sheet 54 opposite to the light guide plate 53. These recess portions 57 each have side surfaces 57a extending substantially parallel to the side surfaces 56a of each of the projecting portions 56 and an upper surface 57b extending substantially parallel to the contact surface 56b of each of the projecting portions 56.

According to this embodiment, a plurality of projecting portions 56 and a plurality of recess portions 57 are provided in the form of a matrix on the surface (surface extending along arrow Y1) of the reflective sheet 54 closer to the light guide plate 53 and the surface (surface extending along arrow Y2) of the reflective sheet 54 opposite to the light guide plate 53, respectively, as shown in FIG. 5. The plurality of projecting portions 56 and the plurality of recess portions 57 are arranged substantially uniformly over a substantially entire region of the surface (surface extending along arrow Y1) of the reflective sheet 54 closer to the light guide plate 53 and a substantially entire region of the surface (surface extending along arrow Y2) of the reflective sheet 54 opposite to the light guide plate 53, respectively at constant intervals.

According to this embodiment, an arrangement interval D between the plurality of projecting portions 56 is larger than the protrusion height H of each of the projecting portions 56, as shown in FIG. 3. This protrusion height H of each of the projecting portions 56 is preferably at least 0.3 mm. As shown in FIG. 5, each of the projecting portions 56 (recess portions 57) has a substantially round shape in plan view (as viewed along arrow Y1). The diameter R (see FIGS. 3 and 5) of each of the projecting portions 56 having the substantially round shape is preferably not more than 1 mm.

According to the aforementioned structure, the light emitted from the LEDs 51 comes into a light-receiving surface 53a (end surface extending along arrow Z2) of the light guide plate 53, and thereafter is repetitively multiply-reflected by the reflective sheet 54 to be emitted from a light-emitting surface 53b (surface extending arrow Y1) of the light guide plate 53. Then, the light emitted from the light-emitting surface 53b of the light guide plate 53 is applied to the liquid crystal display cell 60 after the luminance or the like thereof is adjusted by the optical sheet 55. Thus, the liquid crystal display cell 60 displays an image.

Furthermore, according to the aforementioned structure, heat generated when the LEDs 51 emit the light is transferred to the rear plate 42 through the glass epoxy board 52 and the heat sink 43, and thereafter radiated by the rear plate 42. At this time, part of heat transferred from the LEDs 51 to the rear plate 42, not radiated by the rear plate 42 is transferred to the light guide plate 53 through the projecting portions 56 of the reflective sheet 54.

According to this embodiment, as hereinabove described, the projecting portions 56 protruding toward the light guide plate 53 (along arrow Y1) and coming into contact with the light guide plate 53 are provided on the surface (surface extending along arrow Y1 (see FIG. 3)), closer to the light guide plate 53, of the reflective sheet 54 of the liquid crystal display module 40, whereby spaces including air having small thermal conductivity can be provided between the light guide plate 53 and the reflective sheet 54. Furthermore, a contact area between the light guide plate 53 and the reflective sheet 54 can be further reduced as compared with a case where a surface of the light guide plate 53 is in contact with the substantially entire surface of the reflective sheet 54 closer to the light guide plate 53. Consequently, transfer of heat from the LEDs 51 to the liquid crystal display cell 60 through the reflective sheet 54 and the light guide plate 53 can be inhibited.

According to this embodiment, as hereinabove described, the projecting portions 56 each are formed in the shape having the side surfaces 56a and the contact surface 56b coming into surface contact with the light guide plate 53. Thus, the projecting portions 56 each having the contact surface 56b coming into surface contact with the light guide plate 53 can stably support the light guide plate 53 dissimilarly to a case where the projecting portions 56 each are formed in such a shape that the projecting portions 56 each come into point contact with the light guide plate 53. Consequently, the transfer of heat from the LEDs 51 to the liquid crystal display cell 60 through the reflective sheet 54 and the light guide plate 53 can be inhibited while the light guide plate 53 is stably supported.

According to this embodiment, as hereinabove described, the plurality of projecting portions 56 are formed on the surface (surface extending along arrow Y1 (see FIG. 3)) of the reflective sheet 54 closer to the light guide plate 53. Thus, the light guide plate 53 can be stably supported by the plurality of projecting portions 56.

According to this embodiment, as hereinabove described, the plurality of projecting portions 56 are arranged over the substantially entire region of the surface (surface extending along arrow Y1) of the reflective sheet 54 closer to the light guide plate 53. Thus, the light guide plate 53 can be more stably supported by the plurality of projecting portions 56 arranged over the substantially entire region of the surface (surface extending along arrow Y1) of the reflective sheet 54 closer to the light guide plate 53.

According to this embodiment, as hereinabove described, the plurality of projecting portions 56 are arranged substantially uniformly over the substantially entire region of the surface (surface extending along arrow Y1) of the reflective sheet 54 closer to the light guide plate 53. Thus, the light guide plate 53 can be further stably supported by the plurality of projecting portions 56 arranged substantially uniformly over the substantially entire region of the surface (surface extending along arrow Y1) of the reflective sheet 54 closer to the light guide plate 53.

According to this embodiment, as hereinabove described, the arrangement interval D (see FIG. 3) between the plurality of projecting portions 56 is larger than the protrusion height H (see FIG. 3) of each of the projecting portions 56. Thus, the spaces including air having small thermal conductivity, surrounded by the projecting portions 56, the light guide plate 53, and the reflective sheet 54 can be further widened as compared with a case where the arrangement interval D between the plurality of projecting portions 56 is smaller than the protrusion height H of each of the projecting portions 56, so that the transfer of heat from the LEDs 51 to the liquid crystal display cell 60 through the reflective sheet 54 and the light guide plate 53 can be further inhibited.

According to this embodiment, as hereinabove described, the rear plate 42 made of metal, having a function of radiating heat from the LEDs 51 is so provided as to come into contact with the surface (surface extending along arrow Y2 (see FIG. 3)) of the reflective sheet 54 opposite to the surface on which the projecting portions 56 are formed. Thus, heat transferred from the LEDs 51 to the reflective sheet 54 can be reduced by the rear plate 42 having a function of radiating heat from the LEDs 51.

According to this embodiment, as hereinabove described, the recess portions 57 having the shapes corresponding to the shapes of the projecting portions 56 are formed at the positions, corresponding to the projecting portions 56, of the surface (surface extending along arrow Y2 (see FIG. 3)) of the reflective sheet 54 opposite to the light guide plate 53. Thus, transfer of heat from the LEDs 51 to the reflective sheet 54 can be more effectively inhibited by spaces including air having small thermal conductivity, constituted by the recess portions 57.

According to this embodiment, as hereinabove described, the projecting portions 56 are formed integrally on the surface (surface extending along arrow Y1) of the reflective sheet 54 closer to the light guide plate 53. Thus, the number of components can be reduced dissimilarly to a case where the projecting portions 56 and the reflective sheet 54 are provided separately from each other.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to the liquid crystal television as an example of the display device in the aforementioned embodiment, the present invention is not restricted to this. The present invention is also applicable to another display device such as a monitor of a PC (personal computer).

While the projecting portions 56 each are formed in the shape having the side surfaces 56a and the contact surface 56b coming into surface contact with the light guide plate 53, as shown in FIG. 6 in the aforementioned embodiment, the present invention is not restricted to this. In the present invention, the projecting portions each may alternatively be so formed in a shape (hemisphere shape, for example) having no side surface as to come into point contact with the light guide plate.

While the projecting portions 56 are formed integrally on the plate-like reflective sheet 54 by texturing, as shown in FIG. 6 in the aforementioned embodiment, the present invention is not restricted to this. In the present invention, the projecting portions may not be formed integrally with the reflective sheet.

While the projecting portions 56 each have the rectangular section, as shown in FIG. 6 in the aforementioned embodiment, the present invention is not restricted to this. In the present invention, projecting portions 58 each having a trapezoidal section may alternatively be formed as in a modification shown in FIG. 7. These projecting portions 58 according to the modification each are formed in a shape having side surfaces 58a inclined with respect to a direction (along arrow Y1) perpendicular to a reflective sheet 54 and a contact surface 58b coming into surface contact with a light guide plate 53, as shown in FIG. 7. In this modification, recess portions 59 each having side surfaces 59a extending substantially parallel to the side surfaces 58a of each of the projecting portions 58 and an upper surface 59b extending substantially parallel to the contact surface 58b of each of the projecting portions 58 are formed at positions, corresponding to the projecting portions 58, of a surface (surface extending along arrow Y2) of the reflective sheet 54 opposite to the light guide plate 53.

While the recess portions 57 having the shapes corresponding to the shapes of the projecting portions 56 are formed at the positions, corresponding to the projecting portions 56, of the surface (surface extending along arrow Y2) of the reflective sheet 54 opposite to the light guide plate 53, as shown in FIG. 6 in the aforementioned embodiment, the present invention is not restricted to this. In the present invention, the shapes of the recess portions may not correspond to the shapes of the projecting portions. Furthermore, in the present invention, no recess portion may be formed on the reflective sheet.

While the projecting portions 56 each have the substantially round shape in plan view (as viewed along arrow Y1), as shown in FIG. 5 in the aforementioned embodiment, the present invention is not restricted to this. In the present invention, the projecting portions may alternatively be formed in a rectangular shape or a polygon shape other than the rectangular shape in plan view.

While the plurality of projecting portions 56 are arranged substantially uniformly over the substantially entire region of the surface (surface extending along arrow Y1) of the reflective sheet 54 closer to the light guide plate 53, as shown in FIG. 5 in the aforementioned embodiment, the present invention is not restricted to this. In the present invention, the plurality of projecting portions may alternatively be biased to a prescribed region of the surface of the reflective sheet closer to the light guide plate, or randomly arranged on the surface of the reflective sheet closer to the light guide plate.

What is claimed is:

1. A display module comprising:
a display cell;
a light source;
a light guide plate including a light-receiving surface receiving light from said light source, guiding said light received by said light-receiving surface to said display cell; and
a reflective sheet reflecting said light received by said light-receiving surface of said light guide plate toward said display cell, arranged on a side opposite to said display cell with respect to said light guide plate, wherein
a projecting portion protruding toward said light guide plate and coming into contact with said light guide plate is formed on a surface of said reflective sheet closer to said light guide plate.

2. The display module according to claim 1, wherein
said projecting portion is formed in a shape having side surfaces and a contact surface coming into surface contact with said light guide plate.

3. The display module according to claim 1, wherein
a plurality of said projecting portions are formed on said surface of said reflective sheet closer to said light guide plate.

4. The display module according to claim 3, wherein
said plurality of projecting portions are arranged over a substantially entire region of said surface of said reflective sheet closer to said light guide plate.

5. The display module according to claim 4, wherein
said plurality of projecting portions are arranged substantially uniformly over said substantially entire region of said surface of said reflective sheet closer to said light guide plate.

6. The display module according to claim 3, wherein
an arrangement interval between said plurality of projecting portions is larger than a protrusion height of each of said projecting portions.

7. The display module according to claim 1, further comprising a heat radiation member having a function of radiating heat from said light source, so provided as to come into contact with a surface of said reflective sheet opposite to said surface on which said projecting portion is formed.

8. The display module according to claim 7, wherein
said heat radiation member includes a plate-like member made of metal.

9. The display module according to claim 1, wherein
a recess portion having a shape corresponding to a shape of said projecting portion is formed at a position, corresponding to said projecting portion, of a surface of said reflective sheet opposite to said light guide plate.

10. The display module according to claim 1, wherein
said projecting portion is formed integrally on said surface of said reflective sheet closer to said light guide plate.

11. A display device comprising:
a display module; and
a housing storing said display module inside, wherein
said display module includes:
a display cell,
a light source,
a light guide plate including a light-receiving surface receiving light from said light source, guiding said light received by said light-receiving surface to said display cell, and
a reflective sheet reflecting said light received by said light-receiving surface of said light guide plate toward said display cell, arranged on a side opposite to said display cell with respect to said light guide plate, and
a projecting portion protruding toward said light guide plate and coming into contact with said light guide plate is formed on a surface of said reflective sheet of said display module closer to said light guide plate.

12. The display device according to claim 11, wherein
said projecting portion is formed in a shape having side surfaces and a contact surface coming into surface contact with said light guide plate.

13. The display device according to claim 11, wherein
a plurality of said projecting portions are formed on said surface of said reflective sheet closer to said light guide plate.

14. The display device according to claim 13, wherein
said plurality of projecting portions are arranged over a substantially entire region of said surface of said reflective sheet closer to said light guide plate.

15. The display device according to claim 14, wherein
said plurality of projecting portions are arranged substantially uniformly over said substantially entire region of said surface of said reflective sheet closer to said light guide plate.

16. The display device according to claim 13, wherein
an arrangement interval between said plurality of projecting portions is larger than a protrusion height of each of said projecting portions.

17. The display device according to claim 11, further comprising a heat radiation member having a function of radiating heat from said light source, so provided as to come into contact with a surface of said reflective sheet opposite to said surface on which said projecting portion is formed.

18. The display device according to claim 17, wherein
said heat radiation member includes a plate-like member made of metal.

19. The display device according to claim 11, wherein
a recess portion having a shape corresponding to a shape of said projecting portion is formed at a position, corresponding to said projecting portion, of a surface of said reflective sheet opposite to said light guide plate.

20. A liquid crystal television set comprising:
a liquid crystal display module; and
a television housing storing said liquid crystal display module inside, wherein
said liquid crystal display module includes:
a liquid crystal display cell,
a light source,
a light guide plate including a light-receiving surface receiving light from said light source, guiding said light received by said light-receiving surface to said liquid crystal display cell, and
a reflective sheet reflecting said light received by said light-receiving surface of said light guide plate toward said liquid crystal display cell, arranged on a side opposite to said liquid crystal display cell with respect to said light guide plate, and
a projecting portion protruding toward said light guide plate and coming into contact with said light guide plate is formed on a surface of said reflective sheet of said liquid crystal display module closer to said light guide plate.
